(19) United States
(12) Patent Application Publication
(10) Pub. No.: US 2026/0184582 A1
(43) Pub. Date: Jul. 2, 2026

(54) LITHIUM ION CONDUCTOR AND ALL SOLID STATE BATTERY COMPRISING THE SAME

(71) Applicants: SAMSUNG ELECTRO-MECHANICS CO., LTD., Suwon-si, Gyeonggi-do (KR); Bass Co., Ltd., Asan-si, Chungcheongnam-do (KR)

(72) Inventors: Kyongbok Min, Suwon-si, Gyeonggi-do (KR); Han Kim, Suwon-si, Gyeonggi-do (KR); Jongmin Kim, Suwon-si, Gyeonggi-do (KR); Kil Ho Kim, Yongin-si, Gyeonggi-do (KR); Daehyun Kim, Asan-si, Chungcheongnam-do (KR); Taeho Park, Seoul (KR); Shiwoo Lee, Suwon-si, Gyeonggi-do (KR); Duckhyun Chang, Suwon-si, Gyeonggi-do (KR); Emmanuel Kwame Ampadu, Asan-si, Chungcheongnam-do (KR); Poo Reum Choi, Hwaseong-si, Gyeonggi-do (KR)

(73) Assignees: SAMSUNG ELECTRO-MECHANICS CO., LTD., Suwon-si, Gyeonggi-do (KR); Bass Co., Ltd., Asan-si, Chungcheongnam-do (KR)

(21) Appl. No.: 18/729,800

(22) PCT Filed: Jun. 14, 2024
(86) PCT No.: PCT/KR2024/008189

§ 371 Date: Jul. 17, 2024

(30) Foreign Application Priority Data
Jun. 29, 2023 (KR) 10-2023-0084194
Jan. 19, 2024 (KR) 10-2024-0008535

(51) Int. Cl. C01D 15/04; H01M 4/02; H01M 4/525; H01M 4/583; H01M 4/66; H01M 10/0562; H01M 10/058

(52) U.S. Cl. CPC C01D 15/04; H01M 4/525; H01M 4/583; H01M 4/66; H01M 10/0562; H01M 10/058; C01P 2002/04; C01P 2002/72; C01P 2002/88; C01P 2004/03; C01P 2006/40; H01M 2004/021; H01M 2004/027; H01M 2004/028; H01M 2300/0071

(57) ABSTRACT

The lithium ion conductor for an all-solid-state battery according to the present disclosure is represented by Chemical Formula 1.

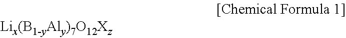

In Chemical Formula 1,
4.2≤x≤6.0, 0.15≤y≤0.45, and z≥1.1, and
X is F, Cl, Br, or I.

### TECHNICAL FIELD

The present disclosure relates to a lithium ion conductor and an all-solid-state battery including the same.

### BACKGROUND ART

Recently, as portable electronic devices are required to be down-sized and used for a long term, high-capacity batteries are required, and safety of the batteries is also required due to the spread of wearable electronic devices. Accordingly, development of an all-solid-state battery using a solid electrolyte instead of a liquid electrolyte is actively progressing.

Since the all-solid-state battery does not use a flammable organic solvent, additional circuitry for safety may be simplified. Therefore, the all-solid-state battery is expected as a technology capable of manufacturing a safe battery with high capacity per unit volume.

In addition, an oxide all-solid-state battery using an oxide electrolyte with lower ionic conductivity (10⁻⁴ S/cm to 10⁻⁶ S/cm) than a sulfide electrolyte (10⁻² S/cm) requires a high-temperature sintering process but exhibits excellent stability, compared to a sulfide all-solid-state battery using the sulfide electrolyte which reacts with oxygen and moisture in the air.

The stacked oxide all-solid-state battery is an ultra-small battery, which can be mounted on a substrate like a passive device, and is stable even when exposed to high temperatures during the reflow process.

### DISCLOSURE OF INVENTION

### Solution to Problem

One aspect of the embodiment provides a lithium ion conductor for an all-solid-state battery that can be sintered at low temperature.

Another aspect of the embodiment provides an all-solid-state battery that includes the lithium ion conductor and has high ionic conductivity and excellent reliability.

However, the object to be achieved by the embodiments is not limited to the above-mentioned object but may be variously expanded without departing from the technical spirit of the embodiments.

### Advantageous Effects of Invention

According to the lithium ion conductor according to the embodiment, sintering at low temperature may be enabled, and when used in an all-solid-state battery, there is an advantage that an all-solid-state battery with high ionic conductivity and excellent reliability can be implemented.

However, the various advantageous advantages and effects of the present invention are not limited to the above descriptions, and will be more easily understood in the process of describing specific embodiments of the present invention.

### BRIEF DESCRIPTION OF DRAWINGS

FIG. 1 is an XRD graph measured on a lithium ion conductor according to an embodiment.

FIG. 2 is a DTA (Differential Thermal Analysis) analysis graph measuring the crystallization temperature of a lithium ion conductor according to an embodiment.

FIG. 3 is an XRD graph measured on the lithium ion conductors included in the all-solid-state battery cells according to Examples 1 to 4.

FIG. 4 is a perspective view schematically illustrating an all-solid-state battery according to another embodiment.

FIG. 5 is a cross-sectional view of an all-solid-state battery according to the embodiment shown in FIG. 4.

FIG. 6 is an exploded perspective view schematically illustrating a unit cell stack structure of the all-solid-state battery according to the embodiment shown in FIG. 4.

FIG. 7 shows scanning electron microscope (SEM) images showing the densities of the lithium ion conductors prepared in (a) Comparative Preparation Example 1 and (b) Preparation Example 1.

FIG. 8 is a graph showing the results of initial charge/discharge evaluation for the all-solid-state battery cells manufactured in Example 1 and Comparative Example 1.

### BEST MODE FOR CARRYING OUT THE INVENTION

A lithium ion conductor for an all-solid-state battery according to an embodiment is represented by Chemical Formula 1.

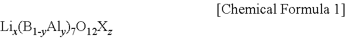

In Chemical Formula 1, 4.2≤x≤6.0, 0.15≤y≤0.45, and z≥1.1, and X is F, Cl, Br, or I.

The lithium ion conductor may have a crystallinity of 65% to 100% calculated by Equation 1.

$$Crystallinity ( \% ) = [ Ic / ( Ic + Ia ) ] \times 100 \qquad [ Equation 1 ]$$

In Equation 1, Ic is a sum of integrated values of scattering intensities of crystalline peaks in the X-ray diffraction analysis spectrum of the lithium ion conductor, and

Ia is a sum of integral values of the scattering intensities of the amorphous halo in the X-ray diffraction analysis spectrum of the lithium ion conductor.

The lithium ion conductor includes a crystal, and the crystal may include a first crystal represented by LiₐB_{7-b}Al_{b}O₁₂X_{c} and a second crystal represented by Li₄B₇O₁₂ X. In the first crystal, 3.5≤a≤4, 0<b<7, and 0.9≤c≤1, and in the first crystal and the second crystal, X is F, Cl, Br, or I.

A crystallization ratio of the first crystal and the second crystal may be 2.5:1 to 20:1.

A lithium ionic conductivity (25° C.) of the lithium ion conductor may be greater than or equal to 1.0×10⁻⁵ S/cm.

A crystallization temperature (Tc) of the lithium ion conductor may be 400° C. to 500° C.

A method of preparing a lithium ion conductor according to an embodiment includes melting and cooling a precursor mixture including lithium (Li) oxide, boron (B) oxide, aluminum (Al) oxide, and lithium halide (Li—X); and heat-treating the precursor mixture to prepare a lithium ion conductor represented by Chemical Formula 1.

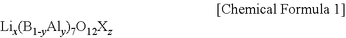

In Chemical Formula 1,
4.2≤x≤6.0, 0.15≤y≤0.45, and z≥1.1, and
X is F, Cl, Br, or I.

The precursor mixture may include 25 mol % to 30 mol % of the lithium (Li) oxide, 35 mol % to 45 mol % of the boron (B) oxide, 10 mol % to 20 mol % of the aluminum (Al) oxide, and 15 mol % to 30 mol % of the lithium halide (Li—X, where X is F, Cl, Br, or I) based on a total of 100 mol % of the precursor mixture.

The heat-treating of the precursor mixture may be performed at a temperature of 350° C. to 550° C.

An all-solid-state battery according to an embodiment includes a solid electrolyte layer and a positive electrode layer and a negative electrode layer disposed with the solid electrolyte layer therebetween, wherein any one selected from the solid electrolyte layer, positive electrode layer, negative electrode layer, and a combination thereof includes a lithium ion conductor, and

the lithium ion conductor is represented by Chemical Formula 1.

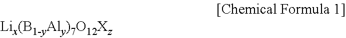

In Chemical Formula 1,
4.2≤x≤6.0, 0.15≤y≤0.45, and z≥1.1, and
X is F, Cl, Br, or I.

A crystallinity of the lithium ion conductor of the all-solid-state battery as calculated by Equation 1 may be 65% to 100%.

$$Crystallinity ( \% ) = [ Ic / ( Ic + Ia ) ] \times 100 \qquad [ Equation 1 ]$$

In Equation 1, Ic is a sum of integrated values of scattering intensities of crystalline peaks in the X-ray diffraction analysis spectrum of the lithium ion conductor, and

Ia is a sum of integral values of the scattering intensities of the amorphous halo in the X-ray diffraction analysis spectrum of the lithium ion conductor.

The lithium ion conductor of the all-solid-state battery may include a crystal, and the crystal may include a first crystal represented by LiₐB_{7-b}Al_{b}O₁₂X, and a second crystal represented by Li₄B₇O₁₂X. In the first crystal, 3.5≤a≤4, 0<b<7, and 0.9≤c≤1, and in the first or second crystal, X may be F, Cl, Br, or I.

A crystallization ratio of the first crystal and the second crystal may be 2.5:1 to 20:1.

A lithium ionic conductivity (25° C.) of the lithium ion conductor of the all-solid-state battery may be greater than or equal to 1.0×10⁻⁵ S/cm.

A crystallization temperature (Tc) of the lithium ion conductor of the all-solid-state battery may be 400° C. to 500° C.

### MODE FOR THE INVENTION

Hereinafter, various embodiments of the present invention will be described in detail with reference to the accompanying drawings so that those skilled in the art may easily carry out the present invention. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and substitutions without departing from the scope and spirit of the present invention. In addition, some constituent elements in the accompanying drawings are exaggerated, omitted, or schematically illustrated, and the size of each constituent element does not entirely reflect the actual size.

In addition, unless explicitly described to the contrary, the word “comprise,” and variations such as “comprises” or “comprising,” will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing. In addition, the “lateral direction” refers to a direction extending parallel to the large surface (main surface) from the edge of the sheet-shaped constituent elements or a “planar direction,” which corresponds to an L-axis direction in the drawing. The W-axis direction in the drawing may be the “width direction.”

Hereinafter, various embodiments and modifications will be described in detail with reference to the drawings.

### Lithium Ion Conductor

A lithium ion conductor for an all-solid-state battery according to an embodiment is represented by Chemical Formula 1.

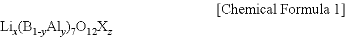

In Chemical Formula 1,
4.2≤x≤6.0, 0.15≤y≤0.45, and z≥1.1, and
X is F, Cl, Br, or I.

When the lithium ion conductor according to an embodiment has the above composition, sintering may be enabled even at low temperatures of 350° C. to 550° C., and when used in an all-solid-state battery, an all-solid-state battery with high ionic conductivity and excellent reliability can be implemented.

As an example, the lithium ion conductor includes crystals, and a crystallinity degree of the lithium ion conductor calculated by Equation 1 may be greater than or equal to 65%, greater than or equal to 80%, or greater than or equal to 90%, and less than or equal to 100%, less than or equal to 99%, or less than or equal to 98%.

$$Crystallinity ( \% ) = [ Ic / ( Ic + Ia ) ] \times 100 \qquad [ Equation 1 ]$$

In Equation 1, Ic is a sum of integrated values of scattering intensities of crystalline peaks in the X-ray diffraction analysis spectrum of the lithium ion conductor, and Ia is a sum of integral values of the scattering intensities of the amorphous halo in the X-ray diffraction analysis spectrum of the lithium ion conductor.

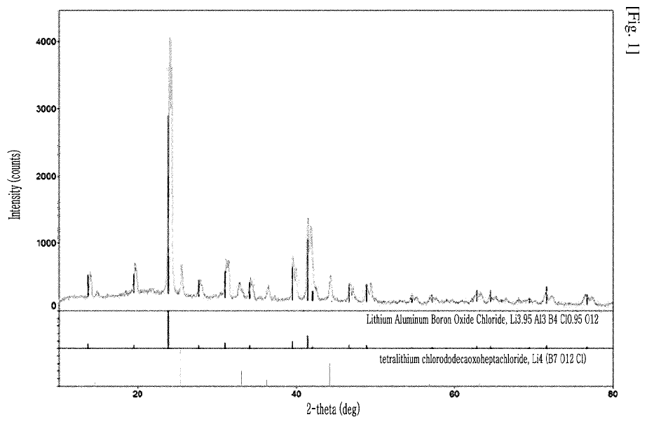

FIG. 1 is an XRD graph measured on a lithium ion conductor according to an embodiment.

Referring to FIG. 1, the lithium ion conductor may be calculated with respect to a degree of crystallinity based on a graph obtained through X-ray diffraction spectroscopy. In the X-ray diffraction analysis spectrum, an X ray wavelength λ with an incident angle θ and a lattice interplanar spacing d has a relationship of 2d·sin θ=nλ, which is called Bragg equation. Accordingly, when the incident angle is determined, the lattice spacing d may be obtained.

However, since random atomic alignments rather than regular atomic alignments appear in an amorphous material, a plurality of X-ray diffractions do not appear at a specific wavelength. Instead, a wide halo pattern appears in a diffraction angle region of 5° to 80°. In a diffraction angle region of 5° to 80°, instead of a peak at a specific angle a diffuse halo pattern appears, which indicates an amorphous material having crystallinity of 0%. However, the surface of the lithium ion conductor, which is exposed to X-rays, should not contain contaminants other than an organic material. Consequently, the analysis may have high reliability only when measured under conditions free from factors affecting diffraction patterns.

In addition, when a portion of the precursor material is excessive, insufficient, or excluded, a crystalline peak may be observed due to an unstable network between amorphous phases, but such a peak corresponds to an artifact in the spectrograph.

When crystals exist in the lithium ion conductors, one or more crystalline peaks exist in the corresponding measurement diffraction angle range. The presence of the peak means that a peak may be recognized at least by naked eyes or clearly distinguished and recognized by a waveform processing unit from the background noise in an X-ray diffraction diagram with maximum intensity in a diffraction angle range of (2θ)=5° to 80° as a full area of a vertical axis in the XRD pattern graph. In particular, a main crystal phase peak has 80% of peak intensity of the lowest peak.

Herein, as crystallinity is higher, a halo region is reduced, and when the crystallinity is 100%, there is no halo region. When crystalline and amorphous are mixed, the crystallinity is obtained by calculating a relative ratio of an area of the crystalline peak region to that of the halo region in a graph of intensity and the diffraction angle range.

A method for measuring the crystallinity of the lithium ion conductor in the all-solid-state battery 100 according to an embodiment is as follows.

First of all, the all-solid-state battery 100 is cut at the center of the W-axis direction in the L-axis and T-axis directions to prepare a cross-sectional sample (Hereinafter, referred to as “cross-sectional sample”), and the cross-sectional sample is pulverized into particles having a size of about 20 μm or more and then, sieved to obtain a sample from which an XRD graph is obtained. Subsequently, data obtained from the XRD graph are inserted into Equation 1 to obtain crystallinity of the lithium ion conductor included in the all-solid-state battery.

The lithium ion conductor may include a crystal, and the crystal may include a first crystal represented by LiₐB_{7-b}Al_{b}O₁₂X, and a second crystal represented by Li₄B₇O₁₂X.

In the first crystal, 3.5≤a≤4, 0<b<7, and 0.9≤c≤1, and in the first or second crystal, X may be F, Cl, Br, or I.

Referring to FIG. 1, in the XRD graph measured from the lithium ion conductor according to an embodiment, peaks of the first crystal and the second crystal, which are the main crystal phases, may be observed.

As a specific example, the first crystal (LiₐB_{7-b}Al_{b}O₁₂X_{c}) may include Li₄B₄Al₃O₁₂Cl, Li_{3.95}B₄Al₃O₁₂Cl_{0.95}, or a combination thereof.

As a specific example, the second crystal (Li₄B—O₁₂X) may include Li₄B₇O₁₂Cl.

The crystal may further include other crystals in addition to the first and second crystals described above.

The crystallinity of the lithium ion conductor according to an embodiment may be a sum of crystallinity of the first crystal, crystallinity of the second crystal, and crystallinity of the other crystals.

In the lithium ion conductor according to an embodiment, the first crystal and the second crystal may have a crystallization ratio of 2.5:1 to 20:1, for example, 3:1 to 17:1.

If each crystallinity of the first crystal and the second crystal and the crystallization ratio satisfy the ranges, low-temperature sintering may be performed, realizing an all-solid-state battery with high ionic conductivity and excellent reliability.

In an embodiment, the lithium ion conductor may have lithium ionic conductivity (25° C.) of 1.0×10⁻⁵ S/cm or more, for example, 5.0×10⁻⁵ S/cm or more, or 1.0×10⁻⁴ S/cm or more. But there is no particular limitation on an upper limit.

The lithium ionic conductivity of the lithium ion conductor may be measured by an AC impedance method.

For example, the lithium ion conductor is manufactured into a pellet, and at both ends of the pellet, electrodes made of gold (Au) are formed to prepare a sample. Subsequently, AC impedance of the sample is measured (frequency: 10⁺⁶ Hz or more to 10¹ Hz or less, voltage: 50 mV to 500 mV) by using an impedance measuring device at room temperature (25° C.) to calculate the ionic conductivity.

For another example, the all-solid-state battery may be ion-milled, polished, or the like to expose the solid electrolyte layer, and a portion of the solid electrolyte layer is sampled as a rectangular plate-shaped piece. Subsequently, at both ends of the obtained piece, electrodes made of gold (Au) are formed, preparing a sample. AC impedance of this sample is measured using the aforementioned method to calculate the ionic conductivity.

FIG. 2 is a DTA (Differential Thermal Analysis) analysis graph measuring the crystallization temperature of a lithium ion conductor according to an embodiment.

For example, the lithium ion conductor may have a glass transition temperature (Tg) of 350° C. to 420° C., for example, 380° C. to 410° C.

For example, the lithium ion conductor may have a crystallization temperature (Tc) of 400° C. to 500° C., for example, 450° C. to 500° C. or 450° C. to 480° C.

Both of the Tg and Tc are inherent to a composition of glass, which may be obtained by using an inflection point, a peak, etc. of a DTA curve representing exothermicity and endothermicity through differential thermal analysis (DTA) of the glass.

Because the lithium ion conductor has the aforementioned composition and thus may sufficiently lower the crystallization temperature, an all-solid-state battery including the same may be manufactured through a co-firing process at a low temperature of 350° C. to 550° C.

The lithium ion conductor according to an embodiment has a low crystallization temperature and thus may be sintered even at a low temperature. If the lithium ion conductor capable of sintering at the low temperature is included in a solid electrolyte layer and an electrode layer of an all-solid-state battery to be described later, the solid electrolyte layer may be formed to be dense, increasing lithium ionic conductivity. In addition, the lithium ion conductor may suppress decomposition of an electrode active material in the electrode layer and minimize a side reaction due to thermal-chemical reactions, realizing an all-solid-state battery with high reliability as well as high capacity.

### Method of Preparing Lithium Ion Conductor

The method of preparing a lithium ion conductor according to an embodiment includes melting and cooling a precursor mixture including lithium (Li) oxide, boron (B) oxide, aluminum (Al) oxide, and lithium halide (Li—X); and heat-treating the precursor mixture to prepare the aforementioned lithium ion conductor represented by Chemical Formula 1. X is F, Cl, Br, or I.

Because the manufactured lithium ion conductor is the same as described above, the following description will focus on the method of preparing the lithium ion conductor.

The precursor mixture may refer to a crystallographically amorphous material, and for example a halo (instead of sharp peaks) may be observed in X-ray diffraction or electron beam diffraction patterns of the precursor mixture.

As an example, the precursor mixture may include lithium oxide (Li₂O), boron oxide B₂O₃, aluminum oxide (Al₂O₃), lithium halide, such as, for example, lithium chloride (LiCl), or a combination thereof.

Before melting the precursor mixture, 25 mol % to 30 mol % of lithium oxide, 35 mol % to 45 mol % of boron oxide, 10 mol % to 20 mol % of aluminum oxide, and 15 mol % to 30 mol % of lithium halide (Li—X) may be mixed.

In the step of melting the precursor mixture, the melting temperature may be greater than or equal to 500° C., or greater than or equal to 600° C., and may be less than or equal to 1200° C., or less than or equal to 1000° C.

The time for melting the precursor mixture may be 20 to 50 minutes, for example, 30 to 40 minutes.

A method of preparing a lithium ion conductor according to an embodiment includes heat treating the molten and cooled precursor mixture. Crystallization may proceed in the precursor mixture through the heat-treating the precursor mixture.

The heat-treating of the precursor mixture may be performed at a temperature in a range from 350° C. to 600° C., for example, in a range from 400° C. to 600° C., in a range from 450° C. to 600° C., or in a range from 450° C. to 550° C.

The heat-treating of the precursor mixture may be performed for period of time in a range from 10 minutes to 120 minutes, for example, in a range from 10 minutes to 100 minutes, in a range from 10 minutes to 60 minutes, in a range from 20 minutes to 60 minutes, or in a range from 20 minutes to 40 minutes.

The heat treatment of the precursor mixture may be performed by using a hot press, which is set at a pressure in a range from 0.5 MPa to 40 MPa.

The lithium ion conductor heat-treated at a temperature under the condition, if applied to an all-solid-state battery, may realize an all-solid-state battery with high ionic conductivity and excellent reliability.

After manufacturing the lithium ion conductor according to an embodiment, the lithium ion conductor may be processed for use into a powder shape, a block shape, a plate shape, a flake shape, and the like.

### All-Solid-State Battery

An all-solid-state battery according to an embodiment includes a solid electrolyte layer and a positive electrode layer and a negative electrode layer disposed with the solid electrolyte layer therebetween, wherein any one selected from the solid electrolyte layer, positive electrode layer, negative electrode layer, and a combination thereof includes a lithium ion conductor, and

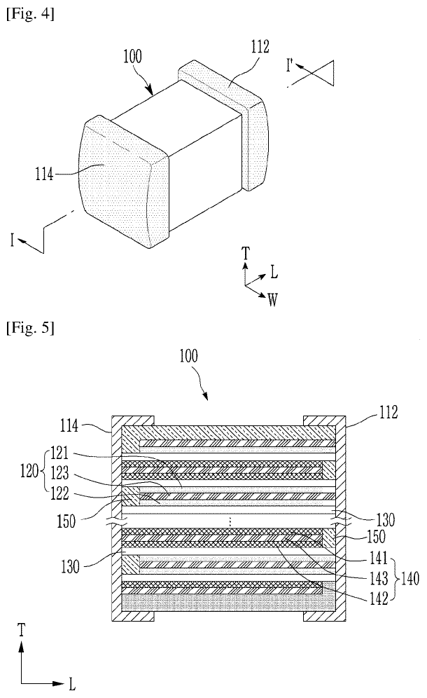

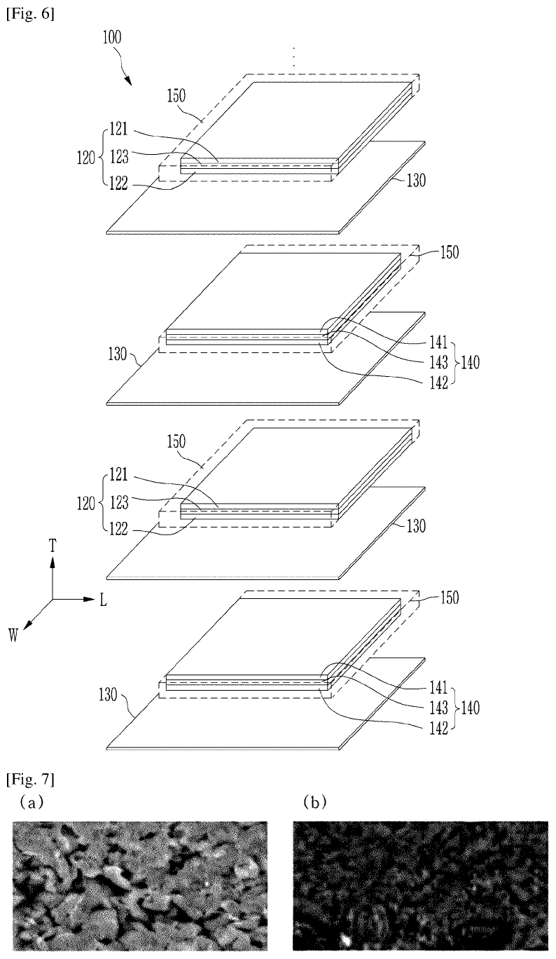

FIG. 4 is a perspective view schematically illustrating an all-solid-state battery according to another embodiment, FIG. 5 is a cross-sectional view of an all-solid-state battery according to the embodiment shown in FIG. 4, and FIG. 6 is an exploded perspective view schematically illustrating a unit cell stack structure of an all-solid-state battery according to the embodiment shown in FIG. 4.

Hereinafter, an all-solid-state battery will be described in detail with reference to FIGS. 4 to 6.

The all-solid-state battery 100 may have, for example, an approximate hexahedral shape.

In the present example embodiment, for convenience of description, in the all-solid-state battery 100, both surfaces facing each other in a thickness direction (T-axis direction) are defined as first and second surfaces, and both surfaces connected to the first and second surfaces and facing each other in a length direction (L-axis direction) are defined as third and fourth surfaces. For example, the first and second surfaces of the all-solid-state battery 100 may be the third and fourth surfaces.

The all-solid-state battery 100 according to the present embodiment includes electrode layers 120 and 140 and a solid electrolyte layer 130 adjacent to the electrode layers 120 and 140 in a stacking direction. The electrode layers 120 and 140 may include a positive electrode layer 120 and a negative electrode layer 140, and may include the current collectors 123 and 143 and the active material layers 121 and 122 coated on at least one surface of the current collector 123, and active material layers 141, and 142 coated on at least one surface of the current collector 143.

The positive electrode layer 120 may be formed by coating the positive electrode active material layers 121 and 122 on at least one surface of the positive electrode current collector 123, and the negative electrode layer 140 may be formed by coating the negative electrode active material layers 141 and 142 on at least one surface of the negative electrode current collector 143. For example, the uppermost electrode layer in the stacking direction may be formed by coating the positive electrode active material layer 122 on one surface of the positive electrode current collector 123, and the lowermost electrode layer may be formed by coating the negative electrode active material layer 141 on one surface of the negative electrode current collector 143. In addition, the electrode layers between the uppermost and lowermost ends are formed by coating the positive electrode active material layers 121 and 122 on both surfaces of the positive electrode current collector 123, or by coating the negative electrode active material layers 141 and 142 on both surfaces of the negative electrode current collector 143.

The positive electrode active material layers 121 and 122 may include a positive electrode active material and, optionally, a solid electrolyte. In addition, the positive electrode active material layers 121 and 122 may optionally further include an additive such as a binder or a conductive agent.

For example, the positive electrode active material is not particularly limited as long as it can secure sufficient capacity of the all-solid-state battery 100. For example, the positive electrode active material may include lithium cobalt oxide, lithium nickel cobalt manganese oxide, lithium nickel cobalt aluminum oxide, lithium iron phosphate, lithium manganese oxide, or a combination thereof.

For example, the positive electrode active material may be compounds represented by the following chemical formulas: LiₐA_{1-b}M_{b}D₂ (wherein 0.90≤a≤1.8, 0≤b≤0.5); LiₐE_{1-b}M_{b}O_{2-c}D_{c} (wherein 0.90≤a≤1.8, 0≤b≤0.5, 0≤c≤0.05); LiE_{2-b}M_{b}O_{4-c}D_{c} (wherein 0≤b≤0.5, 0≤c≤0.05); LiₐNi_{1-b-c}Co_{b}M_{c}D_{α} (wherein 0.90≤a≤1.8, 0≤b≤0.5, 0≤c≤0.05, 0<α≤2); LiₐNi_{1-b-c}Co_{b}M_{c}O_{2-α}X_{α} (wherein 0.90≤a≤1.8, 0≤b≤0.5, 0≤c≤0.05, 0<<<2); LiₐNi_{1-b-c}Co_{b}M_{c}O_{2-α}X₂ (wherein 0.90≤a≤1.8, 0≤b≤0.5, 0≤c≤0.05, 0<<<2); LiₐNi_{1-b-c}Mn_{b}M_{c}D_{α} (wherein 0.90≤a≤1.8, 0≤b≤0.5, 0≤α≤0.05, 0≤α≤2); LiₐNi_{1-b-c}Mn_{b}M_{c}O_{2-α}X_{α} (wherein 0.90≤a≤1.8, 0≤b≤0.5, 0≤c≤0.05, 0<α<2); LiₐNi_{1-b-c}Mn_{b}M_{c}O_{2-α}X₂ (wherein 0.90≤a≤1.8, 0≤b≤0.5, 0≤c≤0.05, 0<α<2); LiₐNi_{b}E_{c}G_{d}O₂ (wherein 0.90≤a≤1.8, 0≤b≤0.9, 0≤c≤0.5, 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, 0.001≤e≤0.1); LiₐNiGbO₂ (wherein 0.90≤a≤1.8, 0.001≤b≤0.1); LiₐCoGbO₂ (wherein 0.90≤a≤1.8, 0.001≤b≤0.1); LiₐMnGbO₂ (wherein 0.90≤a≤1.8, 0.001≤b≤0.1); LiₐMn₂GbO₄ (wherein 0.90≤a≤1.8, 0.001≤b≤0.1); QO₂; QS₂; LiQS₂; V₂ O₅; LiV₂O₂; LiRO₂; LiNiVO₄; Li_{(3-f)}J₂(PO₄)₃ (0≤f≤2); Li_{(3-f)}Fe₂(PO₄)₃ (wherein 0≤f≤2); and LiFePO₄, wherein in the above chemical formulas, A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and J is V, Cr, Mn, Co, Ni, or Cu.

The positive electrode active material may also be LiCoO₂, LiMnₓO₂ₓ (wherein x=1 or 2), LiNi₁₋ₓMnₓO₂ₓ (wherein 0<x<1), LiNi_{1-x-y}CoₓMn_{y}O₂ (wherein 0≤x≤0.5 and 0≤y≤0.5), LiFePO₄, TiS₂, FeS₂, TiS₃, or FeS₃.

The solid electrolyte included in the positive electrode active material layers 121 and 122 may include a lithium ion conductor according to an embodiment disclosed herein. A content of the solid electrolyte may be greater than or equal to 0.1 parts by weight, greater than or equal to 1 part by weight, or greater than or equal to 10 parts by weight, and less than or equal to 80 parts by weight, less than or equal to 60 parts by weight, or less than or equal to 50 parts by weight, based on 100 parts by weight of the total amount of the positive electrode active material.

The conductive agent is not particularly limited as long as it has conductivity without causing chemical change in the all-solid-state battery 100. Examples of the conductive agent may include, but are not limited to, graphite such as natural graphite and artificial graphite; carbon-based substances such as carbon black, acetylene black, ketjen black, channel black, furnace black, lamp black, and summer black; conductive fibers such as carbon fibers and metal fibers; fluorinated carbon; metal powders such as aluminum and nickel powder; conductive whiskers such as zinc oxide and potassium titanate; conductive metal oxides such as titanium oxide; or conductive materials such as polyphenylene derivatives.

A content of the conductive agent may be in a range from 1 part by weight to 10 parts by weight, for example, in a range from 2 parts by weight to 5 parts by weight, based on 100 parts by weight of the positive electrode active material. When the content of the conductive agent is within the above range, a finally obtained electrode may have excellent conductivity characteristics.

A binder may be used to improve bonding strength between an active material and a conductive agent. The binder may include, without limitation, polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene terpolymer (EPDM), sulfonated EPDM, a styrene butadiene rubber, a fluororubber, or various copolymers, and the like.

A content of the binder may be 1 part by weight to 50 parts by weight, for example, 2 parts by weight to 5 parts by weight, based on 100 parts by weight of the total positive electrode active material. When the content of the binder satisfies the above range, the active material layer may have high bonding strength.

As the positive electrode current collector 123, a porous material such as a mesh or mesh shape may be used, and a porous metal plate such as stainless steel, nickel, or aluminum may be used. In addition, the positive electrode current collector 123 may be coated with an oxidation-resistant metal or alloy film to prevent oxidation.

The negative electrode active material layers 141 and 142 may include a negative electrode active material and, optionally, a solid electrolyte. In addition, the negative electrode active material layers 141 and 142 may optionally further include an additive such as a binder or a conductive agent.

The negative electrode active material may be, for example, a carbon-based material, silicon, a silicon oxide, a silicon-based alloy, a silicon-carbon-based material composite, tin, a tin-based alloy, a tin-carbon composite, a metal oxide, or a combination thereof, and may include a lithium metal and/or a lithium metal alloy.

The lithium metal alloy may include lithium and a metal/semi-metal capable of alloying with lithium. For example, the metal/semi-metal capable of alloying with lithium may include Si, Sn, Al, Ge, Pb, Bi, Sb, a Si—Y alloy (wherein Y is an alkali metal, an alkaline-earth metal, Group 13 to Group 16 elements, a transition metal, a rare earth element, or a combination thereof, and Si is not included), a Sn—Y alloy (wherein Y is an alkali metal, an alkaline earth metal, Group 13 to Group 16 elements, a transition metal, or a transition metal oxide such as lithium titanium oxide (Li₄Ti₅O 12), a rare earth element, or a combination thereof, and Sn is not included), or MnOₓ (0<x≤2).

Thus, for example, the element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

In addition, the oxide of a metal/semi-metal capable of alloying with lithium may be lithium titanium oxide, vanadium oxide, lithium vanadium oxide, SnO₂, SiOₓ (0<x<2), and the like. For example, the negative electrode active material may include one or more elements selected from elements of Groups 13 to 16 of the periodic table of elements. For example, the negative electrode active material may include one or more elements selected from the group consisting of Si, Ge, and Sn.

The carbon-based material may be, for example, crystalline carbon, amorphous carbon, or mixtures thereof. The crystalline carbon may include graphite, such as natural graphite or artificial graphite in irregular, plate, flake, spherical, or fibrous form. In addition, the amorphous carbon may include soft carbon (low temperature calcined carbon) or hard carbon, a mesophase pitch carbonization product, calcined coke, graphene, carbon black, fullerene soot, carbon nanotubes, carbon fiber, and the like.

The silicon-based material may be Si, SiOₓ (0<x<2, for example 0.5 to 1.5), Sn, SnO 2, a silicon-containing metal alloy, or a mixture thereof. The silicon-containing metal alloy may include, for example, silicon and one or more of Al, Sn, Ag, Fe, Bi, Mg, Zn, In, Ge, Pb, and Ti.

The solid electrolyte included in the negative electrode active material layers 141 and 142 may include the lithium ion conductor according to an embodiment disclosed herein. A content of the solid electrolyte may be greater than or equal to 0.1 parts by weight, greater than or equal to 1 part by weight, or less than or equal to 10 parts by weight, less than or equal to 80 parts by weight, less than or equal to 60 part by weight, or less than or equal to 50 parts by weight based on 100 parts by weight of the total amount of the negative electrode active material.

The negative electrode active material layer may also optionally include a conductive agent and a binder as described in the positive electrode active material layer.

The negative electrode current collector 143 may be a mesh or mesh-shaped porous body, and a porous metal plate such as stainless steel, nickel, or aluminum. In addition, the negative electrode current collector 143 may be coated with an oxidation-resistant metal or alloy film to prevent oxidation.

The solid electrolyte layer 130 may be interposed and stacked between the positive electrode layer 120 and the negative electrode layer 140. Therefore, the solid electrolyte layer 130 may be adjacently disposed between the positive electrode active material layers 121 and 122 of the positive electrode layer 120 and the negative electrode active material layers 141 and 142 of the negative electrode layer 140 in the stacking direction.

Therefore, in the all-solid-state battery 100, a plurality of positive electrode layers 120 and a plurality of negative electrode layers 140 may be alternately disposed, and a plurality of solid electrolyte layers 130 may be interposed and stacked therebetween.

The all-solid-state battery 100 is a stacked all-solid-state battery 100 manufactured by alternately stacking a plurality of positive electrode layers 120 and negative electrode layers 140, and interposing a plurality of solid electrolyte layers 130 therebetween to provide a cell stack, and then firing them collectively.

As aforementioned, because any one selected from the solid electrolyte layer 130, the positive electrode layer 120, the negative electrode layer 140, and a combination thereof includes the lithium ion conductor according to an embodiment disclosed herein, wherein the lithium ion conductor has a low crystallization temperature of 400° C. to 500° C., if the cell stack is fired all together, and the firing may be performed at a low temperature. Accordingly, the solid electrolyte layer 130, which is formed to be dense, may increase lithium ionic conductivity, suppress decomposition of an electrode active material in the electrode layers 120 and 140, and minimize a side reaction due to thermal-chemical reactions, realizing the all-solid-state battery 100 having high reliability as well as high capacity.

Accordingly, the lithium ion conductor included in any one of the solid electrolyte layer 130, the positive electrode layer 120, the negative electrode layer 140, and a combination thereof may be fired.

The cell stack may be fired all together at a temperature of 550° C. or less, for example, at a temperature in the range of 300° C. to 550° C., in the range of 350° C. to 550° C., or in the range of 350° C. to 500° C.

If the firing temperature is higher than 550° C., the solid electrolyte and the electrode active material may react during the firing process to form by-products, thereby deteriorating characteristics of the all-solid-state battery 100. In addition, if the firing temperature is 550° C. or less, which corresponds to low-temperature firing, because the electrode active material may be selected from a wider range of types, a degree of freedom in designing the all-solid-state battery 100 may be improved.

The solid electrolyte layer 130 includes the lithium ion conductor according to an embodiment disclosed herein.

Also, as an example, the solid electrolyte layer 130 may further include an inorganic solid electrolyte including an oxide-based solid electrolyte, a sulfide-based solid electrolyte, or a combination thereof.

The oxide-based solid electrolyte may be, for example, a garnet-type, NASICON-type, LISICON-type, perovskite-type, LiPON-type, or amorphous (glass) electrolyte.

The garnet-type solid electrolyte may include, without limitation, lithium-lanthanum zirconium oxide (LLZO) represented by LiₐLa_{b}Zr_{c}O₁₂ such as Li₇La₃Zr₂O₁₂, and the NASICON-type solid electrolyte may include a lithium-aluminum-titanium-phosphate salt (LATP) of Li₁₊ₓAlₓTi₂₋ₓ(PO₄)₃ (0<x<1) in which Ti is introduced into a Li₁₊ₓAlₓ M₂₋ₓ(PO₄)₃ (LAMP) (0<x<2, M is Zr, Ti, or Ge) type compound, lithium-aluminum-germanium-phosphate (LAGP) represented by Li₁₊ₓAlₓGe₂₋ₓ(PO₄)₃ (0<x<1) such as Li_{1.3} Al_{0.3}Ti_{1.7}(PO₄)₃ introduced with excess lithium and/or lithium-zirconium-phosphate (LZP) of LiZr₂(PO₄)₃.

In addition, the LISICON-type solid electrolyte may include, for example, a solid solution oxide represented by xLi₃AO₄-(1-x)Li₄BO₄ (wherein A is P, As, or V and B is Si, Ge, or Ti) such as Li₄Zn(GeO₄)₄, Li₁₀GeP₂O₁₂ (LGPO), Li_{3.5}Si_{0.5}P_{0.5}O₄, or Li_{10.42} Si(Ge)_{1.5}P_{1.5}Cl_{0.08}O_{11.92}, or a solid solution sulfide represented by Li₄₋ₓM_{1-y}M′_{y}S₄ (wherein M is Si, or Ge and M′ is P, Al, Zn, or Ga) such as Li₂S—P₂S₅, Li₂S—SiS₂, Li₂S—SiS₂—P₂S₅, or Li₂S-GeS₂.

The perovskite-type solid electrolyte may include lithium lanthanum titanate (LLTO) represented by Li₃ₓLa_{2/3-x}□_{1/3-2x}TiO₃ (0<x<0.16, □: vacancy) such as Li_{1/8}La_{5/8}TiO₃. The LiPON-type solid electrolyte may include a lithium phosphorous oxynitride such as Li_{2.8} PO_{3.3}N_{0.46}.

Examples of the amorphous electrolyte include Li₂O—B₂O₃—SiO₂, Li₂O—B₂O₃—P₂O₅, Li₃ BO₃-Li₂SO₄, or Li₃BO₃-Li₂CO₃.

The sulfide-based solid electrolyte includes sulfur atoms among the electrolyte components and is not particularly limited to specific components, and may include one or more of a crystalline solid electrolyte, an amorphous solid electrolyte (glassy solid electrolyte), or a glass ceramic solid electrolyte.

For example, the sulfide-based solid electrolyte may include LPS-type sulfides including sulfur and phosphorus (for example, Li₂S—P₂S₅), and Thio-LISICON type compounds, such as Li₄-xGel-xPxS4 (where x may be 0.1 to 2, 3/4, or 2/3), Li_{10±1}MP₂X₁₂ (where M is Ge, Si, Sn, or Al, and X is S, or Se), Li_{3.833}Sn_{0.833}As_{0.166}S₄, Li₄SnS₄, Li_{3.2.5} Ge_{0.25}P_{0.75}S₄, Li₂S—P₂S₅, B₂S₃—Li₂S, xLi₂S-(100-x)P₂S₅ (where x is 70 to 80), Li₂S—SiS₂—Li₃N, Li₂S—P₂S₅—LiI, Li₂S—SiS₂—LiI, Li₂S—B₂S₃—LiI, Li₁₀SnP₂S₁₂, and Li_{3.25}Ge_{0.25}P_{0.75}S₄.

The ionic conductivity of the solid electrolyte may be greater than or equal to 1λ10⁻⁶ S/cm. The ionic conductivity may be a value measured at a temperature of 25° C. The ionic conductivity may be greater than or equal to 1×10⁻⁶ S/cm, greater than or equal to 2×10⁻⁶ S/cm, greater than or equal to 3×10⁻⁶ S/cm, greater than or equal to 4×10⁻⁶ S/cm, greater than or equal to 5×10⁻⁶ S/cm, or greater than or equal to 1×10⁻³ S/cm, and the upper limit is not particularly limited. When a solid electrolyte that satisfies the ionic conductivity in the above range is used, the all-solid-state battery 100 can exhibit high output.

The margin insulating layer 150 may be disposed along edges of the positive electrode layer 120 and the negative electrode layer 140. The margin insulating layer 150 may be disposed on the solid electrolyte layer 130 and may be formed laterally adjacent to edges of the positive electrode active material layers 121 and 122 or the negative electrode active material layers 141 and 142. Accordingly, the margin insulating layer 150 may be disposed on the same layer as the positive electrode layer 120 and the negative electrode layer 140.

The margin insulating layer 150 may include an insulating material having an ionic conductivity of less than or equal to 1.0×10⁻¹⁰ S/cm, or less than or equal to 1.0×10⁻⁶ S/cm, and for example, insulating materials such as the aforementioned solid electrolyte material or resin may be included.

For example, the insulating material may be polyolefin such as polyethylene or polypropylene, polyester such as polyethylene terephthalate (PET), polyurethane, or polyimide.

In addition, the margin insulating layer 150 may include an inorganic solid electrolyte including an oxide-based solid electrolyte, a sulfide-based solid electrolyte, or a combination thereof used in the solid electrolyte layer 130. However, the material included in the margin insulating layer 150 is not limited thereto and may include various materials.

The positive electrode layer 120, the solid electrolyte layer 130, the negative electrode layer 140, and the margin insulating layer 150 may be stacked as described above to form a cell stack of the all-solid-state battery 100. A protective layer made of an insulating material may be formed on the upper and lower ends of the cell stack of the all-solid-state battery 100.

In addition, terminals of the positive electrode current collector 123 and the negative electrode current collector 143 are exposed onto both sides of the cell stack of the all-solid-state battery 100, and the external electrodes 112 and 114 are connected to the exposed terminals and combined therewith. In other words, the external electrodes 112 and 114 are connected to the terminal of the positive electrode current collector 123 to form a positive electrode and also, connected to the terminal of the negative electrode current collector 143 to form a negative electrode. When the terminals of the positive electrode current collector 123 and the negative electrode current collector 143 are configured to face in opposite directions from each other, the external electrodes 112 and 114 may also be positioned at both sides, respectively.

The external electrodes 112 and 114 may include a conductive metal and glass.

The conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof.

A glass component included in the first and second external electrodes 112 and 114 may have a composition in which an oxide is mixed. The glass component may include, for example, a silicon oxide, a boron oxide, an aluminum oxide, a transition metal oxide, an alkali metal oxide, an alkaline-earth metal oxide, or a combination thereof. Herein, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba).

A method of forming the first and second external electrodes 112 and 114 is not particularly limited. For example, the method may include dipping the cell stack in a conductive paste including a conductive metal and glass or screen-printing or gravure-printing the conductive paste on the surface of the cell stack. In addition, various methods of applying the conductive paste on the surface of the cell stack or transferring a dry film obtained by drying the conductive paste onto the cell stack may be used.

Hereinafter, specific examples of the invention are presented. However, the examples described below are only intended to specifically illustrate or explain the invention, and the scope of the invention should not be limited thereto.

### EXAMPLES

### Preparation Example 1: Preparation of Lithium Ion Conductor

As precursors for a lithium ion conductor, Li₂O, B₂O₃, Al₂O₃, and LiCl are mixed according to each mol % shown in Table 1 and then, fused and cooled to prepare a precursor mixture. The fused and cooled precursor mixture is heat-treated at 500° C. for 30 minutes to prepare lithium ion conductor powders of Preparation Examples 1 to 4 having compositions in Table 2.

In addition, the prepared lithium ion conductor powders are measured with respect to a glass transition temperature (Tg) and a crystallization temperature (Tc), and the results are shown in Table 2.

Furthermore, the lithium ion conductor powders are respectively manufactured in the form of a pellet, and on both ends of the pellet, an electrode made of gold (Au) is formed to prepare a sample. Subsequently, AC impedance of the sample is measured (frequency: 10⁺⁶ Hz or more to 10¹ Hz or less, voltage: 50 mV to 500 mV) by using an impedance measuring device at room temperature (25° C.) to calculate ionic conductivity, and the results are shown in Table 2.

TABLE 2

| | Liₓ(B_{1 y}Al_{y})₇O₁₂Cl_{z} | | | | | | | Ionic |
|---|---|---|---|---|---|---|---|---|
| Composition of | Li | B | Al | | Cl | Tg | Tc | conductivity |
| lithium ion conductor | x | 7 (1 − y) | 7y | O | z | (° C.) | (° C.) | (S/cm) |
| Preparation Example 1 | 4.5 | 4.9 | 2.0 | 12 | 1.3 | 405 | 480 | 1.00E−05 |
| Preparation Example 2 | 4.7 | 4.8 | 2.0 | 12 | 1.2 | 398 | 470 | 1.00E−05 |
| Preparation Example 3 | 5.0 | 4.8 | 2.0 | 12 | 1.3 | 385 | 460 | 1.00E−05 |
| Preparation Example 4 | 4.5 | 5.0 | 1.9 | 12 | 1.1 | 380 | 450 | 3.00E−05 |
| Comparative | 4.0 | 4.0 | 3.0 | 12 | 1.0 | 400 | 500 | 1.00E−05 |
| Preparation Example 1 | | | | | | | | |
| Comparative | 4.0 | 4.2 | 2.8 | 12 | 1.0 | — | — | No |
| Preparation Example 2 | | | | | | | | vitrification |

TABLE 1

| | Li₂O | B₂O₃ | Al₂O₃ | LiCl |
|---|---|---|---|---|
| Glass | (mol %) | (mol %) | (mol %) | (mol %) |
| Preparation Example 1 | 25.5 | 38.5 | 16.0 | 20.0 |
| Preparation Example 2 | 27.2 | 37.8 | 16.0 | 19.0 |
| Preparation Example 3 | 28.4 | 36.6 | 15.5 | 19.5 |
| Preparation Example 4 | 27.2 | 40.4 | 14.9 | 17.5 |
| Comparative Preparation | 23.4 | 31.2 | 23.5 | 21.9 |
| Example 1 | | | | |
| Comparative Preparation | 25.0 | 33.3 | 25.1 | 16.7 |
| Example 2 | | | | |

### Preparation Example 2: Manufacturing of All-solid-state Battery Cell

A solid electrolyte layer green sheet including the fused and cooled precursor mixture is manufactured. A positive electrode layer green sheet is manufactured by including 70 wt % of LiCoO₂ (LCO) as a positive electrode active material and 30 wt % of the lithium ion conductor. A negative electrode layer green sheet is manufactured by including 70 wt % of graphite as a negative electrode active material and 30 wt % of the lithium ion conductor.

The manufactured positive electrode layer green sheet, the solid electrolyte layer green sheet, and the negative electrode layer green sheet are stacked and then, simultaneously fired with a hot press at 500° C. for 30 minutes at 40 MPa to manufacture each all-solid-state battery cell according to Examples 1 to 4 and Comparative Examples 1 to 2.

In the manufactured all-solid-state battery cell, the solid electrolyte layer has a thickness of 30 μm, the positive electrode layer has a thickness of 12 μm, and the negative electrode layer has a thickness of 7 μm.

### EVALUATION EXAMPLES

### Evaluation Example 1: Crystallinity Evaluation

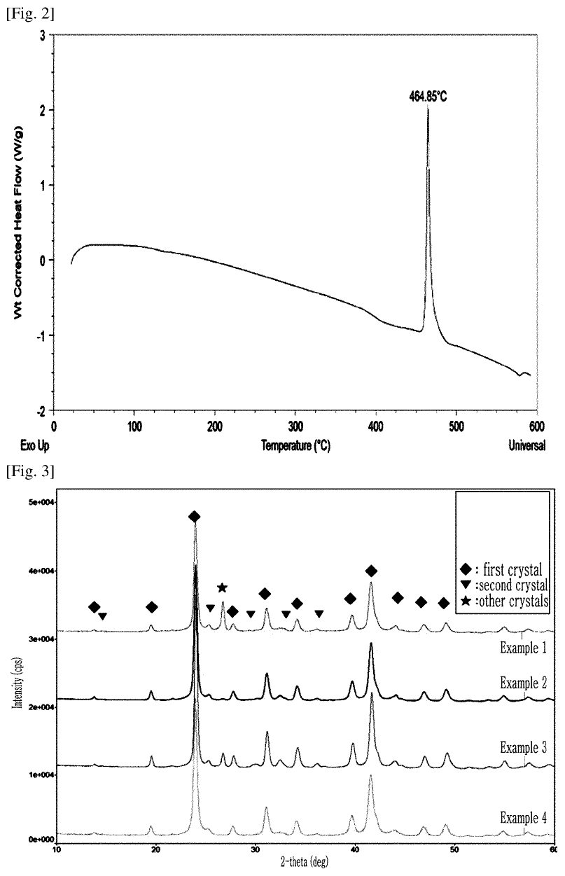

The all-solid-state battery cells according to Examples 1 to 4 and Comparative Examples 1 to 2 are evaluated with respect to crystallinity, and the results are shown in Table 3 and FIG. 3.

As a result of the evaluation, it is confirmed that the first crystal is Li₄B₄Al₃O₁₂Cl, and the second crystal is Li₄B₇O₁₂Cl.

In order to evaluate this, each of the all-solid-state battery cells is cut in the center of the W-axis direction in the L-axis and T-axis directions to prepare a cross-sectional sample, and the cross-sectional sample is pulverized into about 20 μm or more and then, sieved to obtain an XRD graph of the sample. Subsequently, data obtained from the graph are inserted into Equation 1 to calculate crystallinity and a crystallization ratio of the first and second crystals.

$$Crystallinity ( \% ) = [ Ic / ( Ic + Ia ) ] \times 100 \qquad [ Equation 1 ]$$

In Equation 1, Ic is a sum of integrated values of scattering intensities of crystalline peaks in the X-ray diffraction analysis spectrum of the lithium ion conductor, and Ia is a sum of integral values of the scattering intensities of the amorphous halo in the X-ray diffraction analysis spectrum of the lithium ion conductor.

TABLE 3

| | | Crystallization ratio |
|---|---|---|
| | Crystallinity | of first crystal |
| | (%) | and second crystal |
| Example 1 | 92.8 | 15.4:1 |
| Example 2 | 97.0 | 16.6:1 |
| Example 3 | 97.1 | 9.5:1 |
| Example 4 | 97.8 | 10.1:1 |
| Comparative Example 1 | >95 | 18.3:1 |
| Comparative Example 2 | >95 | 17.6:1 |

### Evaluation Example 2: Density Evaluation of Lithium Ion Conductor

In order to evaluate density of the lithium ion conductors prepared in Preparation Example 1 and Comparative Preparation Example 1, each lithium ion conductor is prepared into a sample in the form of a pellet, of which a scanning electron microscope (SEM) image is taken and then, shown in FIG. 7.

The sample image of Comparative Preparation Example 1 is shown in (a) of FIG. 7 is, and the sample image of Preparation Example 1 is shown in (b) of FIG. 7.

Referring to FIG. 7, the lithium ion conductor of Preparation Example 1 shows excellent density, compared to that of Comparative Preparation Example 1.

### Evaluation Example 3: Capacity Evaluation of all-Solid-State Battery Cell

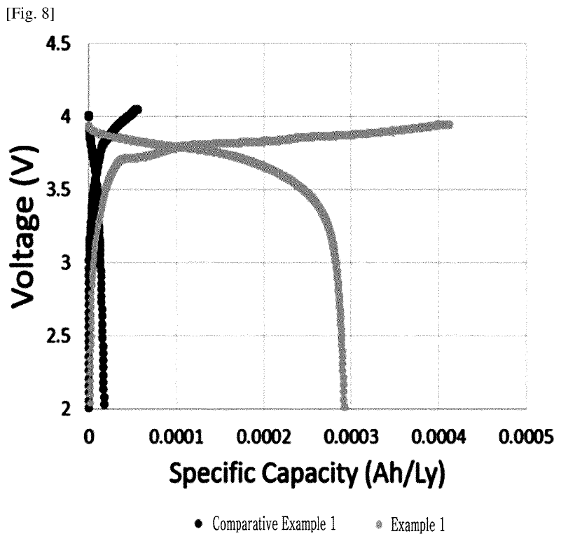

The all-solid-state battery cells of Example 1 and Comparative Example 1 are evaluated with respect to initial charge and discharge, and the results are shown in FIG. 8.

The all-solid-state battery cells of Example 1 and Comparative Example 1 are charged at 0.02 C to 4.3 V and discharged at 0.02 C to 2.0 V to evaluate charge and discharge.

Referring to FIG. 8, the all-solid-state battery cell of Example 1 exhibits much excellent battery capacity by securing a dense electrolyte even at a low temperature, compared to that of Comparative Example 1.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### INDUSTRIAL APPLICABILITY

The present disclosure relates to a lithium ion conductor capable of sintering at a low temperature, which when applied to an all-solid-state battery, realizes high ionic conductivity and excellent reliability of the all-solid-state battery, and thus may be applied to various electrochemical devices and electronic devices.

### DESCRIPTION OF SYMBOLS

100: all-solid-state battery
112, 114: external electrode
120: positive electrode layer
121, 122: positive electrode active material layer
123: positive electrode current collector
130: solid electrolyte layer
140: negative electrode layer
141, 142: negative electrode active material layer
143: negative electrode current collector
150: margin insulating layer

1. A lithium ion conductor being represented by Chemical Formula 1:
Liₓ(B_{1-y}Al_{y})₇O₁₂X₂ [Chemical Formula 1]
wherein, in Chemical Formula 1,
4.2≤x≤6.0, 0.15≤y≤0.45, and z≥1.1, and
X is F, Cl, Br, or I.

2. The lithium ion conductor of claim 1, wherein
the lithium ion conductor has a crystallinity of 65% to 100% calculated by Equation 1:
Crystallinity (%)=[Ic/(Ic+Ia)]×100 [Equation 1]
wherein, in Equation 1, Ic is a sum of integrated values of scattering intensities of crystalline peaks in an X-ray diffraction analysis spectrum of the lithium ion conductor, and
Ia is a sum of integral values of the scattering intensities of the amorphous halo in an X-ray diffraction analysis spectrum of the lithium ion conductor.

3. The lithium ion conductor of claim 1, wherein
the lithium ion conductor includes a crystal, and
the crystal includes a first crystal represented by LiₐB_{7-b}Al_{b}O₁₂Xₑ and a second crystal represented by Li₄B₇O₁₂X:
in the first crystal, 3.5≤a≤4, 0<b<7, and 0.9≤c≤1, and
in the first crystal and the second crystal, X is F, Cl, Br, or I.

4. The lithium ion conductor of claim 3, wherein
a crystallization ratio of the first crystal and the second crystal is 2.5:1 to 20:1.

5. The lithium ion conductor of claim 1, wherein
a lithium ionic conductivity at 25° C. of the lithium ion conductor is greater than or equal to 1.0λ10⁻⁵ S/cm.

6. The lithium ion conductor of claim 1, wherein
a crystallization temperature (Tc) of the lithium ion conductor is 400° C. to 500° C.

7. A method of preparing a lithium ion conductor, comprising melting and cooling a precursor mixture including lithium (Li) oxide, boron (B) oxide, aluminum (Al) oxide, and lithium halide (Li—X); and heat-treating the precursor mixture, to prepare lithium ion conductor represented by Chemical Formula 1:
Liₓ(B_{1 y}Al_{y})₇O₁₂X₂ [Chemical Formula 1]
wherein, in Chemical Formula 1,
4.2≤x≤6.0, 0.15≤y≤0.45, and z≥1.1, and
X is F, Cl, Br, or I.

8. The method of claim 7, wherein
the precursor mixture includes 25 mol % to 30 mol % of the lithium (Li) oxide, 35 mol % to 45 mol % of the boron (B) oxide, 10 mol % to 20 mol % of the aluminum (Al) oxide, and 15 mol % to 30 mol % of the lithium halide (LiX), where X is F, Cl, Br, or I, based on a total of 100 mol % of the precursor mixture.

9. The method of claim 7, wherein
the heat-treating of the precursor mixture is performed at a temperature of 350° C. to 550° C.

10. An all-solid-state battery, comprising
a solid electrolyte layer and a positive electrode layer and a negative electrode layer disposed with the solid electrolyte layer therebetween, wherein any one selected from the solid electrolyte layer, the positive electrode layer, the negative electrode layer,
and a combination thereof includes a lithium ion conductor, and the lithium ion conductor is represented by Chemical Formula 1:
Liₓ(B_{1-y}Al_{y})₇O₁₂X₂ [Chemical Formula 1]
wherein, in Chemical Formula 1,
4.2≤x≤6.0, 0.15≤y≤0.45, and z≥1.1, and
X is F, Cl, Br, or I.

11. The all-solid-state battery of claim 10, wherein
a crystallinity of the lithium ion conductor calculated by Equation 1 is 65% to 100%:
Crystallinity (%)=[Ic/(Ic+Ia)]×100 [Equation 1]
wherein, in Equation 1, Ic is a sum of integrated values of scattering intensities of crystalline peaks in an X-ray diffraction analysis spectrum of the lithium ion conductor, and
Ia is a sum of integral values of the scattering intensities of the amorphous halo in an X-ray diffraction analysis spectrum of the lithium ion conductor.

12. The all-solid-state battery of claim 10, wherein
the lithium ion conductor includes a crystal, and
the crystal includes a first crystal represented by LiₐB_{7-b}Al_{b}O₁₂Xₑ and a second crystal represented by Li₄B₇O₁₂X:
in the first crystal, 3.5≤a≤4, 0<b<7, and 0.9≤c≤1, and
in the first crystal or second crystal, X is F, Cl, Br, or I.

13. The all-solid-state battery of claim 12, wherein
a crystallization ratio of the first crystal and the second crystal is 2.5:1 to 20:1.

14. The all-solid-state battery of claim 10, wherein
a lithium ionic conductivity at 25° C. of the lithium ion conductor is greater than or equal to 1.0λ10⁻⁵ S/cm.

15. The all-solid-state battery of claim 10, wherein
a crystallization temperature (Tc) of the lithium ion conductor is 400° C. to 500° C.

16. The lithium ion conductor of claim 1, wherein z is less than or equal to 1.4

17. The all-solid-state battery of claim 10, wherein the positive electrode layer has a thickness greater than that of the negative electrode layer, and the solid electrolyte layer has a thickness greater than both the positive and negative electrode layers.

18. A method of manufacturing an all-solid-state battery, comprising:
preparing a solid electrolyte layer green sheet including a fused and cooled precursor mixture;
preparing a positive electrode layer green sheet including a positive electrode active material and a lithium ion conductor;
preparing a negative electrode layer green sheet including a negative electrode active material and the lithium ion conductor;
stacking the positive electrode layer green sheet, the solid electrolyte layer green sheet and the negative electrode green sheet; and
firing the stack with a hot press under pressure,
wherein the precursor mixture comprises Li₂O, B₂O₃, Al₂O₃ and LiX, X being selected from the group consisting of F, Cl, Br and I, and
wherein the lithium ion conductor is represented by Chemical Formula 1:
Liₓ(B_{1-y}Al_{y})₇O₁₂X₂ [Chemical Formula 1]
wherein, in Chemical Formula 1,
4.2≤x≤6.0, 0.15≤y≤0.45, and z≥1.1, and
X is F, Cl, Br, or I.

19. The method of claim 18, wherein firing is performed at a temperature in a range from 300° C. to 600° C.

20. The method of claim 18, wherein firing is performed under a pressure in a range from 20 MPa to 60 MPa.

21. The method of claim 18, wherein preparing the solid electrolyte layer green sheet comprises:
melting and cooling the precursor mixture; and
heat-treating the precursor mixture.

22. The method of claim 21, wherein the heat-treating of the precursor mixture is performed at a temperature of 350° C. to 550° C.

23. The method of claim 21, wherein the heat-treating is performed at a pressure in a range from 0.5 MPa to 40 MPa.

24. The method of claim 18, wherein a content of lithium ion conductor in the positive electrode layer green sheet and/or the negative electrode layer green sheet is in a range from 10% to 80%.

25. The method of claim 18, wherein the positive electrode active material is selected from the group consisting of lithium cobalt oxide, lithium nickel cobalt manganese oxide, lithium nickel cobalt aluminum oxide, lithium iron phosphate, lithium manganese oxide, and a combination thereof.

26. The method of claim 18, wherein the negative electrode active material is selected from the group consisting of a carbon-based material, silicon, a silicon oxide, a silicon-based alloy, a silicon-carbon-based material composite, tin, a tin-based alloy, a tin-carbon composite, a metal oxide, a lithium metal, a lithium metal alloy and a combination thereof.

27. The method of claim 18, wherein the solid electrolyte layer further comprises inorganic solid electrolyte including an oxide-based solid electrolyte, a sulfide-based solid electrolyte, or a combination thereof.
